(19) United States
(12) Patent Application Publication
(10) Pub. No.: US 2016/0189401 A1
(43) Pub. Date: Jun. 30, 2016

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yoshihito Machida, Sagamihara-shi (JP)

(21) Appl. No.: 14/957,933

(22) Filed: Dec. 3, 2015

(30) Foreign Application Priority Data
Dec. 24, 2014 (JP) 2014-261245

(51) Int. Cl. G06T 11/00; G06T 5/50; G06T 5/00; G06T 11/60

(52) U.S. Cl. CPC G06T 11/005; G06T 11/60; G06T 5/50; G06T 5/002; G06T 2211/421; G06T 2211/436; G06T 2207/10081

(57) ABSTRACT

An image processing apparatus generates a reconstructed image based on a plurality of images. The image processing apparatus includes: an image input unit configured to input the plurality of images; a calculation count setting unit configured to set a calculation count in accordance with an application purpose of the reconstructed image; and a reconstruction processing unit configured to generate the reconstructed image by performing reconstruction calculation on the plurality of images repeatedly based on the calculation count.

### BACKGROUND OF THE INVENTION

1. Field of the Invention

The present invention relates to an image processing apparatus, an image processing method, and a storage medium.

2. Description of the Related Art

A tomography apparatus which performs image reconstruction processing obtains a plurality of images from different angles and of different forms, from these obtained images, one tomographic image by using a technique called an image reconstruction method. As the image reconstruction method, Japanese Patent Laid-Open No. 2006-25868 describes, for example, reconstruction processing called a sequential approximation method. Japanese Patent Laid-Open No. 2006-25868 describes, when performing reconstruction by the sequential approximation method, a method of setting a region of interest on a reconstructed image having an intermediate result and determining whether to perform further calculation based on a standard deviation in that region.

A reconstructed image includes images for various applications and purposes. There are, for example, a simple reconstructed image, as a reconstructed image not used for a diagnosis, to check whether an object is moving immediately after imaging, a diagnostic image which is used to see a relatively large tumor or the like and thus need not be a high-resolution reconstructed image, and a diagnostic image which needs to be a high-resolution reconstructed image to see calcification or the like. Required image quality and a calculation time (calculation speed) needed for reconstruction processing differ in accordance with these applications. It is therefore necessary to be able to set a repetitive calculation count in accordance with these.

The present invention has been made in consideration of the above-described problems and provides an image processing technique capable of generating reconstructed images in accordance with application purposes.

### SUMMARY OF THE INVENTION

According to one aspect of the present invention, there is provided an image processing apparatus which generates a reconstructed image based on a plurality of images, the apparatus comprising: an image input unit configured to input the plurality of images; a calculation count setting unit configured to set a calculation count in accordance with an application purpose of the reconstructed image; and a reconstruction processing unit configured to generate the reconstructed image by performing reconstruction calculation on the plurality of images repeatedly based on the calculation count.

According to another aspect of the present invention, there is provided an image processing apparatus which generates a reconstructed image based on a plurality of images, the apparatus comprising: an image input unit configured to input the plurality of images; a calculation count setting unit configured to set a calculation count based on a parameter including characteristics of the plurality of input images and a characteristic of the reconstructed image to be generated; and a reconstruction processing unit configured to generate the reconstructed image by performing reconstruction calculation on the plurality of images repeatedly based on the calculation count.

According to still another aspect of the present invention, there is provided an image processing method of generating a reconstructed image based on a plurality of images, the method comprising: inputting the plurality of images; setting a calculation count in accordance with an application purpose of the reconstructed image; and generating the reconstructed image by performing reconstruction calculation on the plurality of images repeatedly based on the calculation count.

According to yet another aspect of the present invention, there is provided an image processing method of generating a reconstructed image based on a plurality of images, the method comprising: inputting the plurality of images; setting a calculation count based on a parameter including characteristics of the plurality of input images and a characteristic of the reconstructed image to be generated; and generating the reconstructed image by performing reconstruction calculation on the plurality of images repeatedly based on the calculation count.

Further features of the present invention will become apparent from the following description of exemplary embodiments (with reference to the attached drawings).

### BRIEF DESCRIPTION OF THE DRAWINGS

FIG. 1 is a block diagram showing the arrangement of an image processing apparatus;

FIG. 2 is a flowchart for explaining the overall procedure of processing performed by the image processing apparatus;

FIG. 3 is a block diagram showing the arrangement of a reconstruction processing unit;

FIG. 4 is a flowchart for explaining the processing sequence of the reconstruction processing unit;

FIGS. 5A and 5B are tables exemplifying setting examples of parameters and a calculation count;

FIG. 6 is a graph exemplifying the relationship between the calculation count and a coefficient;

FIG. 7 is a block diagram showing the arrangement of a calculation count setting unit;

FIG. 8 is a flowchart for explaining the processing sequence of the calculation count setting unit; and

FIG. 9 is a block diagram showing the arrangement of an image processing apparatus according to a modification.

### DESCRIPTION OF THE EMBODIMENTS

Exemplary embodiments of the present invention will now be described in detail with reference to the accompanying drawings. Note that the constituent elements described in the embodiments are merely examples. The technical scope of the present invention is determined by the scope of claims and is not limited by the following individual embodiments.

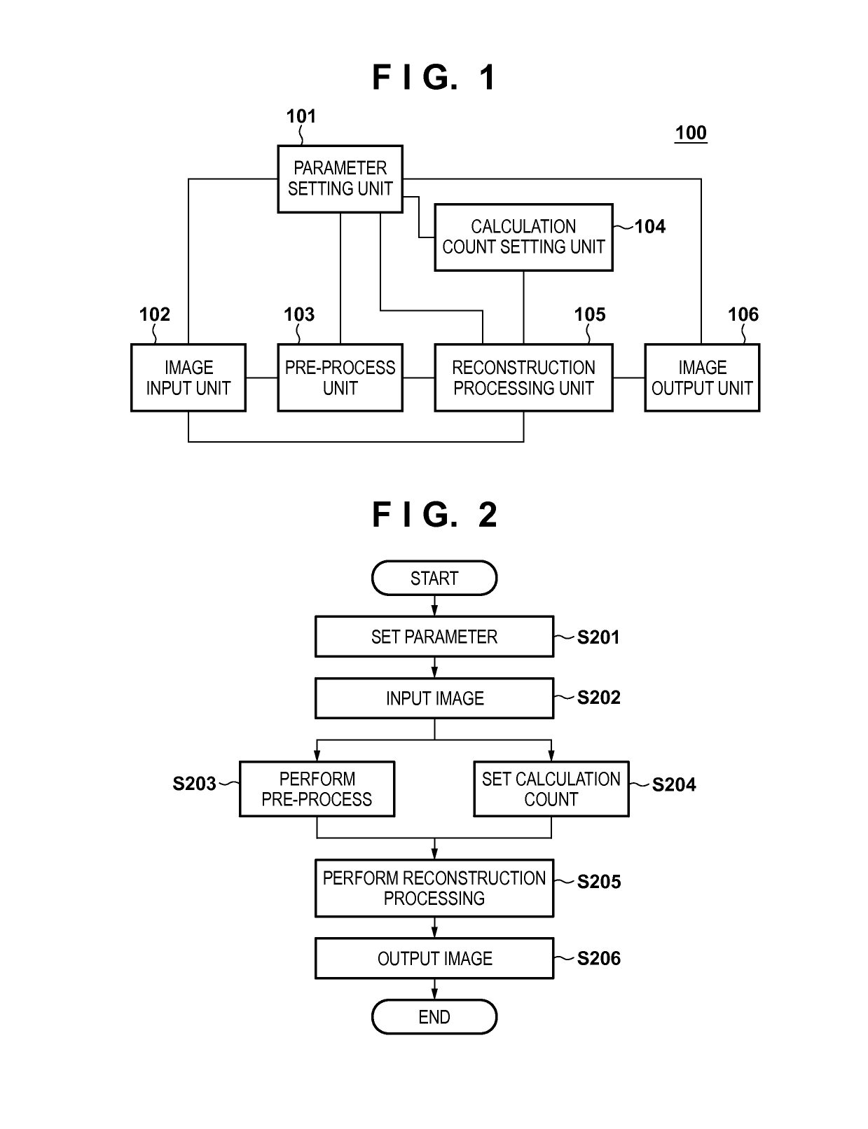

An image processing apparatus (tomographic image reconstruction apparatus) according to an embodiment of the present invention generates a reconstructed image based on a plurality of images. The arrangement of this image processing apparatus will be described with reference to FIG. 1. FIG. 1 is a block diagram exemplifying the functional arrangement of an image processing apparatus 100. The image processing apparatus 100 includes a parameter setting unit 101, an image input unit 102, a pre-process unit 103, a calculation count setting unit 104, a reconstruction processing unit 105, and an image output unit 106.

The parameter setting unit 101 sets a parameter based on an application purpose of a reconstructed image specified via an operation unit (not shown). Then, the parameter setting unit 101 sets parameters for the image input unit 102, the pre-process unit 103, the reconstruction processing unit 105, the calculation count setting unit 104, and the image output unit 106 (an image input parameter to perform input processing on the plurality of images, a pre-process parameter to perform a pre-process, a reconstruction parameter to generate a reconstructed image, and an image output parameter to perform output processing on the reconstructed image) and outputs the set parameters. The image input parameter contains, for example, information indicating the number of pixels and the number of images to be input. The reconstruction parameter contains information indicating the number of pixels of the reconstructed image, a slice interval, and a slice thickness.

The image input unit 102 inputs the plurality of images. That is, the image input unit 102 inputs, based on the image input parameter, the plurality of images (to be referred to as projection images hereinafter) captured from different angles. The image input unit 102 can be configured as, for example, a tomography apparatus such as an X-ray CT apparatus or a saving apparatus which saves an image obtained from the tomography apparatus.

If the image input unit 102 is configured as the tomography apparatus, an image captured by the tomography apparatus is input based on the image input parameter. If the image input unit 102 is configured as the saving apparatus, the image which has already been captured by the tomography apparatus based on the image input parameter is input from the tomography apparatus and saved in the saving apparatus.

The pre-process unit 103 performs, based on the pre-process parameter input from the parameter setting unit 101, the pre-process on each projection image input from the image input unit 102.

The calculation count setting unit 104 sets a calculation count in accordance with the application purpose of the reconstructed image. The application purpose of the reconstructed image includes either a simple display purpose or a diagnostic display purpose. The calculation count setting unit 104 can set, in accordance with the characteristic (for example, image quality) of the reconstructed image and the calculation conditions (for example, the calculation speed and the calculation time) of the reconstructed image, the calculation count in accordance with the application purpose of the reconstructed image. For example, the calculation count setting unit 104 can set the calculation count based on a parameter regarding quality of the reconstructed image generated in accordance with the application purpose and a reconstruction calculation speed. This describes the function of the calculation count setting unit 104 in terms of image quality and the reconstruction calculation speed. There is a relationship in which as the reconstruction calculation speed increases, the calculation time needed for reconstruction calculation is shortened. If the function of the calculation count setting unit 104 is put another way in terms of image quality and the calculation time, the calculation count setting unit 104 can set the calculation count based on the parameter regarding quality of the reconstructed image generated in accordance with the application purpose and a reconstruction calculation time. More specifically, based on the image input parameter, the pre-process parameter, and the reconstruction parameter input from the parameter setting unit 101, the calculation count setting unit 104 can determine the calculation count based on the application purpose of the reconstructed image and set the calculation count for the reconstruction processing unit 105.

The reconstruction processing unit 105 generates the reconstructed image by performing reconstruction calculation on the plurality of images repetitively based on the calculation count. That is, the reconstruction processing unit 105 performs, based on the reconstruction parameter input from the parameter setting unit 101 and the calculation count input from the calculation count setting unit 104, reconstruction processing on the pre-processed images obtained from the pre-process unit 103, thereby generating the reconstructed image. Note that the pre-process need not always be performed. For example, if the image input parameter and the pre-process parameter set by the parameter setting unit 101 are the same, the pre-process is omitted and the reconstruction processing unit 105 can directly use the images input by the image input unit 102 for reconstruction processing.

The image output unit 106 outputs the reconstructed image generated by the reconstruction processing unit 105. The image output unit 106 performs output processing set by the image output parameter on the reconstructed image and outputs the reconstructed image. Output processing set by the image output parameter includes a noise reduction process.

(Processing Sequence of Image Processing Apparatus)

The operation of the aforementioned image processing apparatus 100 will now be described with reference to FIG. 2. FIG. 2 is a flowchart for explaining the overall procedure of processing performed by the image processing apparatus 100. First, in step S201, the parameter setting unit 101 sets the parameters (the image input parameter, the pre-process parameter, the reconstruction parameter, and the image output parameter) to be input to the image input unit 102, the pre-process unit 103, the reconstruction processing unit 105, the calculation count setting unit 104, and the image output unit 106. Each parameter will be described in detail later.

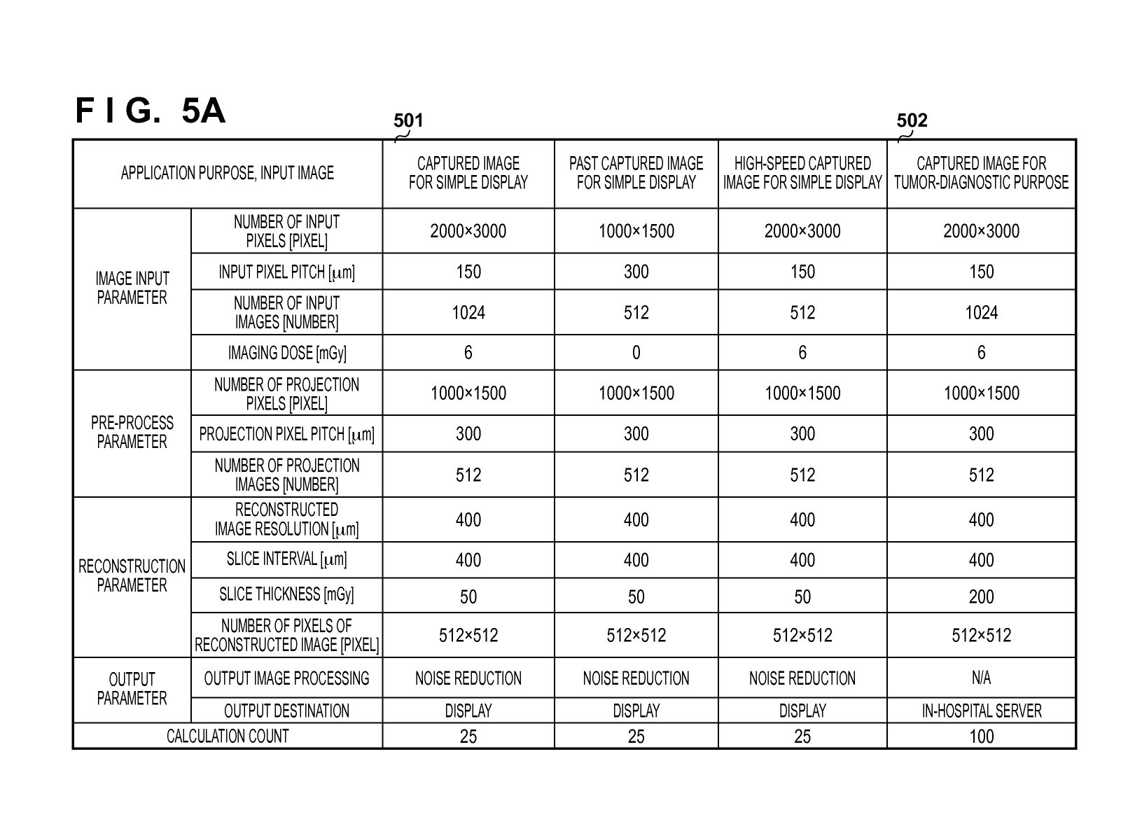

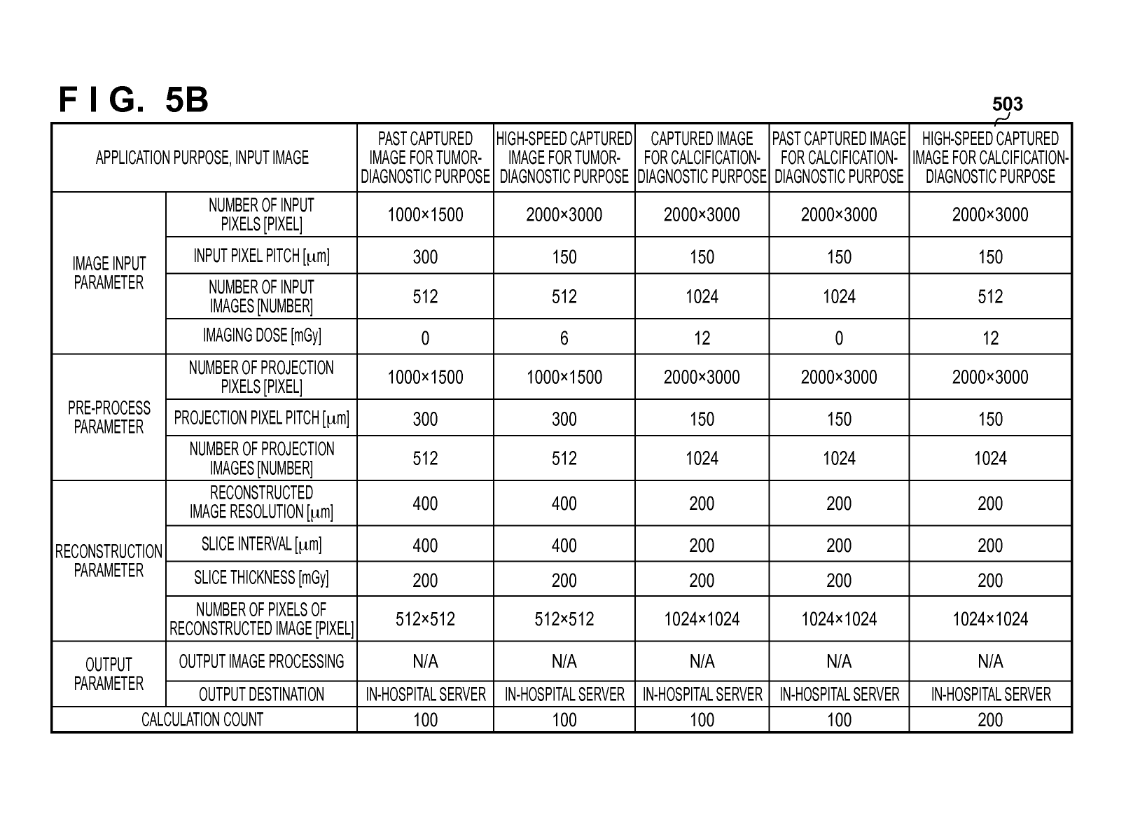

The parameter setting unit 101 can set each parameter in accordance with the application purpose of the reconstructed image. Examples of the application purposes include a preview display purpose (simple display purpose) used to check whether an image has been captured properly, a tumor-diagnostic purpose used when a large and low-contrast object such as a tumor is a diagnostic target, and a calcification-diagnostic purpose used when a small and high-contrast object such as a bone, calcification, an angiographic blood vessel, or the like is a diagnostic target. In this embodiment, a case in which an input image is a captured image and the reconstructed image is used for the simple display purpose (a captured image for simple display 501 in FIGS. 5A and 5B) will be described hereinafter as an example. Note that the present invention is not limited to this example, and can equally be applied to a process for the reconstructed image used to diagnose a tumor, calcification, or the like.

In step S202, the image input unit 102 inputs the plurality of projection images based on the image input parameter set by the parameter setting unit 101 and outputs them to the pre-process unit 103. The image input parameter includes, for example, the number of pixels, a pixel pitch, the number of input images, and an imaging dose. In this embodiment, taking the setting of the captured image for simple display 501 in FIGS. 5A and 5B as an example, the number of pixels is 2,000×3,000 pixels, the pixel pitch is 150 μm, the number of projection images is 1,024, and the imaging dose is 6 mGy.

In this embodiment, the tomography apparatus will be described as an example of the arrangement of the image input unit 102. However, the present invention is not limited to this example. An apparatus which reads out the image that has already been captured by the tomography apparatus and saved may be configured as the image input unit 102.

In step S203, the pre-process unit 103 performs, based on the pre-process parameter, the pre-process on the projection images input from the image input unit 102. The pre-process parameter includes the number of pixels, a pixel pitch, the number of projection images, and the like. In this embodiment, taking the setting of the captured image for simple display 501 in FIGS. 5A and 5B as the example, the number of pixels is 1,000×1,500 pixels, the pixel pitch is 300 μm, and the number of images is 512.

While the number of pixels is 2,000×3,000 pixels, the pixel pitch is 150 μm, and the number of projection images is 1,024 in the image input parameter, the number of pixels is 1,000×1,500 pixels, the pixel pitch is 300 μm, and the number of images is 512 in the pre-process parameter. An adjustment for image quality and the calculation speed (calculation time) can be made by changing the number of pixels, the pixel pitch, and the number of images as described above.

The resolution, the number of images, and the like of the pre-process parameter can be determined in accordance with an application purpose such as the preview display purpose or a diagnostic purpose by using a low-resolution reconstructed image. The pre-process unit 103 performs a process of changing the number of pixels within one projection image in accordance with the pre-process parameter in order to change the resolution. In this embodiment, the number of pixels is halved so as to change the pixels of the pixel pitch from 150 μm to 300 μm. As a method of changing the number of pixels, the pre-process unit 103 can use, for example, a method of obtaining the average value of a plurality of pixels to set it as a representative pixel value, a method of calculating the representative pixel value by multiplying weighted coefficients with respective surrounding pixels and compositing them, a method of calculating the representative pixel value by selecting a pixel from the plurality of pixels, or the like.

The pre-process unit 103 also performs a process of changing the number of projection images based on the pre-process parameter. In this embodiment, the pre-process unit 103 halves the number of projection images so as to change the number of projection images from 1,024 to 512. As a method of halving the number of images, the pre-process unit 103 can use a method of selecting an image to be used for reconstruction, a method of forming an average image from the plurality of images, a method of compositing the plurality of images by multiplying a weighted coefficient with them, a method of performing interpolation by using the plurality of projection images, or the like.

It becomes possible to use the same captured image input by the image input unit 102 for a plurality of different application purposes by performing the pre-process as described above. The contents of the pre-process performed by the pre-process unit 103 are not limited to the above-described process. The pre-process unit 103 can perform processing such as beam hardening correction and scattered ray correction. As beam hardening correction, the pre-process unit 103 can perform, for example, beam hardening correction processing disclosed in Japanese Patent Laid-Open No. 2006-068397. As scattered ray correction, the pre-process unit 103 can perform, for example, scattered ray correction processing described in Japanese Patent Laid-Open No. 2010-110374.

Note that when the images input by the image input unit 102 are directly used, this step S203 need not always be performed and can be omitted. For example, if the image input parameter and the pre-process parameter set by the parameter setting unit 101 are the same, this step S203 is omitted and the reconstruction processing unit 105 can directly use the images input by the image input unit 102 for reconstruction processing.

In step S204, the calculation count setting unit 104 sets the calculation count based on the image input parameter, the pre-process parameter, and the reconstruction parameter input from the parameter setting unit 101. Then, the calculation count setting unit 104 outputs information on the set calculation count to the reconstruction processing unit 105. By setting the calculation count in accordance with image quality (quality of the reconstructed image to be generated) required for the reconstructed image and the calculation speed (the calculation time needed for reconstruction calculation) required for reconstruction calculation, the calculation count setting unit 104 can control image quality and the calculation speed (calculation time). A calculation count setting method by the calculation count setting unit 104 will be described in detail later.

In step S205, the reconstruction processing unit 105 performs, based on the reconstruction parameter input from the parameter setting unit 101 and the calculation count input from the calculation count setting unit 104, reconstruction processing on the pre-processed projection images input from the pre-process unit 103, thereby generating a reconstructed image. When the images (projection images) input from the image input unit 102 are directly used without performing the pre-process, the reconstruction processing unit 105 performs reconstruction processing on the projection images input from the image input unit 102, thereby generating a reconstructed image. The reconstruction processing unit 105 outputs the generated reconstructed image to the image output unit 106.

The reconstruction parameter includes the resolution of the reconstructed image, the slice interval, the slice thickness, the number of pixels of the reconstructed image, and the like. In this embodiment, taking the setting of the captured image for simple display 501 in FIGS. 5A and 5B as the example, the resolution of the reconstructed image is 400 μm, the slice interval is 400 μm, the slice thickness is 50 mm, and the number of pixels of the reconstructed image is 512×512 pixels. The overview of reconstruction processing by the reconstruction processing unit 105 will be described later.

In step S206, the image output unit 106 outputs, based on the image output parameter input from the parameter setting unit 101, the reconstructed image obtained from the reconstruction processing unit 105. The image output parameter contains information such as the setting of an output image processing method, the output destination of the reconstructed image, and the like. In this embodiment, taking the setting of the captured image for simple display 501 in FIGS. 5A and 5B as the example, a noise reduction process is used as the setting of the output image processing method and the output destination is an external display unit (display). Note that the noise reduction process is merely an example as the output image processing method. The image output unit 106 can also output an image to which another image processing is applied. The image output destination is also an example. The image output unit 106 can also function as a communication unit and, for example, output the image to a database or a server (in-hospital server) such as a PACS, a RIS, an HIS via a network.

As described above, overall processing by the image processing apparatus 100 is completed by performing the process in steps S201 to S206.

(Reconstruction Processing Method)

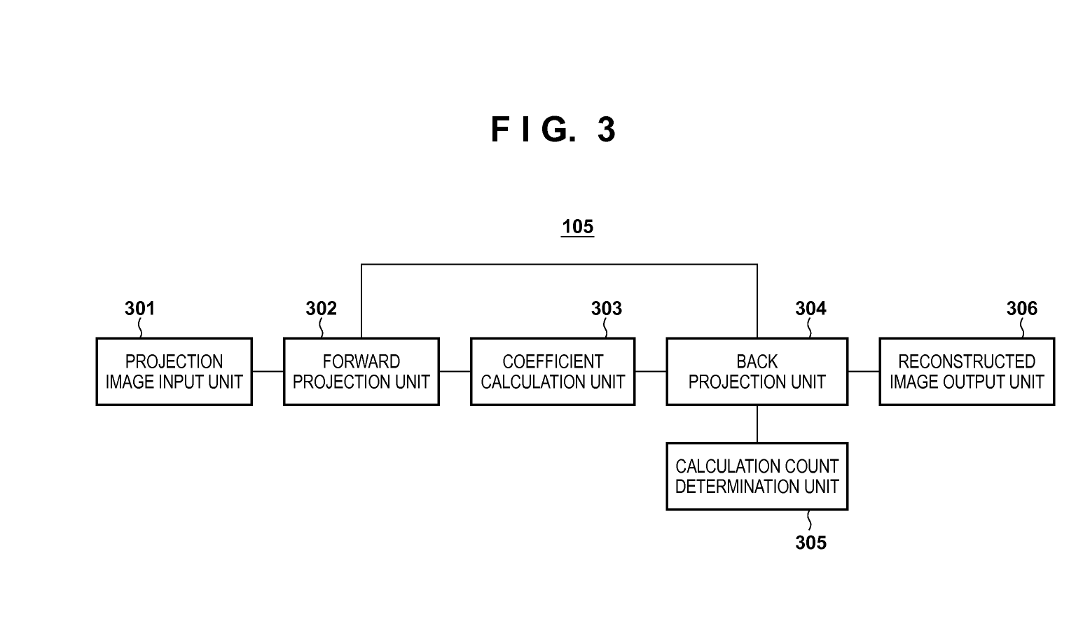

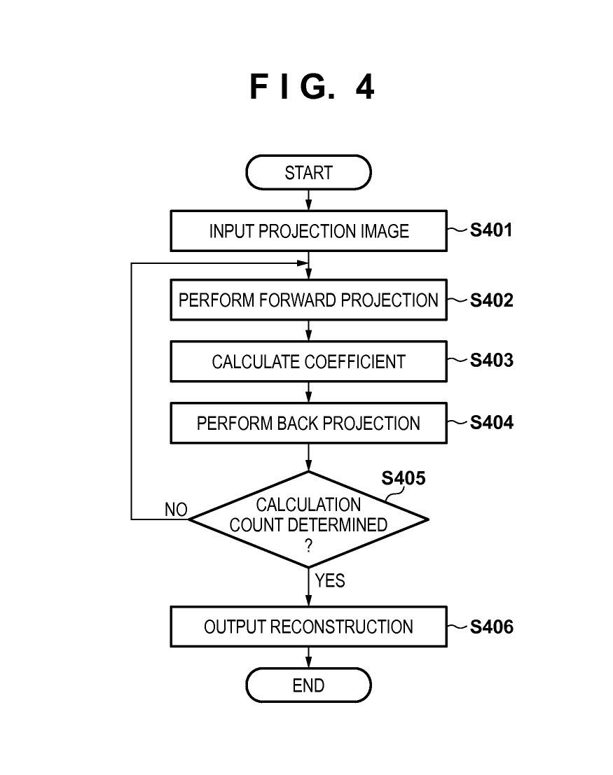

The arrangement of the reconstruction processing unit 105 and the processing sequence of the reconstruction processing method will now be described. FIG. 3 is a block diagram showing the arrangement of the reconstruction processing unit 105. FIG. 4 is a flowchart for explaining the processing sequence of the reconstruction processing unit 105. As shown in FIG. 3, the reconstruction processing unit 105 includes a projection image input unit 301, a forward projection unit 302, a coefficient calculation unit 303, a back projection unit 304, a calculation count determination unit 305, and a reconstructed image output unit 306.

The operation of each unit of the reconstruction processing unit 105 will now be described with reference to the processing sequence in FIG. 4. First, in step S401, the projection image input unit 301 inputs the projection images. The projection images to be input here are the pre-processed projection images output from the pre-process unit 103 when the pre-process has been performed or the projection images output from the image input unit 102 when no pre-process has been performed.

In step S402, the forward projection unit 302 receives the projection images from the projection image input unit 301 and receives a back projection image (reconstructed image) from the back projection unit 304. The forward projection unit 302 generates a forward projection image based on the back projection image (reconstructed image). The forward projection unit 302 generates the forward projection image by sequential approximation calculation such that the forward projection image obtained from the reconstructed image approximates the captured projection image. Note that in the calculation count of 1, the forward projection unit 302 generates the forward projection image based on a reconstructed image (initial reconstructed image) to which an initial value other than 0 is set. For example, in the calculation count of 1, the forward projection unit 302 can obtain the initial reconstructed image from the back projection unit 304 and generate the forward projection image.

In step S403, the coefficient calculation unit 303 performs coefficient calculation by comparing the forward projection image with the back projection image (reconstructed image).

In step S404, the back projection unit 304 updates the back projection image (reconstructed image) based on the back projection image (reconstructed image) that has already been generated and a coefficient obtained by coefficient calculation. Note that in the calculation count of 1, the initial reconstructed image held by the back projection unit 304 in advance is updated based on the coefficient.

In step S405, the calculation count determination unit 305 determines whether calculation by the set calculation count is completed. If calculation by the set calculation count is not completed, the reconstruction processing unit 105 performs reconstruction calculation based on the reconstruction parameter. That is, if calculation by the set calculation count is not completed, the back projection unit 304 outputs the generated back projection image (reconstructed image) to the forward projection unit 302 (No in step S405) and the process returns to step S402.

Also, if calculation by the set calculation count is completed in step S405, the reconstruction processing unit 105 outputs the reconstructed image generated by reconstruction calculation. That is, if calculation by the set calculation count is completed (Yes in step S405), the back projection unit 304 outputs the generated back projection image (reconstructed image) to the reconstructed image output unit 306.

In step S406, the reconstructed image output unit 306 outputs the back projection image (reconstructed image) generated by the back projection unit 304.

As described above, reconstruction processing is completed by performing the process in steps S401 to S406. A sequential approximation method in this embodiment uses the aforementioned method. However, the present invention is not limited to this example. A method of approximating the forward projection image obtained from the reconstructed image to the captured projection image is also applicable.

(Calculation Count Setting Method)

A detailed example of the parameters set by the parameter setting unit 101 and the calculation count set by the calculation count setting unit 104 will now be described. FIGS. 5A and 5B are tables exemplifying setting examples of the parameters (the image input parameter, the pre-process parameter, the reconstruction parameter, and the image output parameter) set by the parameter setting unit 101 and the calculation count set by the calculation count setting unit 104.

The calculation count setting unit 104 can set, to be distinguished from each other, a calculation count for the simple display purpose which is required to display a low-quality reconstructed image at high speed and a calculation count for the diagnostic display purpose which is required to display a high-quality reconstructed image. Alternatively, the calculation count setting unit 104 can set, to be distinguished from each other, the calculation count for the simple display purpose which is required to display the low-quality reconstructed image at high speed, a calculation count for the first diagnostic display purpose which is required to display a noise-reduced reconstructed image, and a calculation count for the second diagnostic display purpose which is required to display a high-quality and noise-reduced reconstructed image.

In the example shown in FIGS. 5A and 5B, the three, (i) simple display which is required to display the low-quality image at high speed, (ii) tumor-diagnostic display (first diagnostic display) which is required to display a low-noise image, and (iii) calcification-diagnostic display (second diagnostic display) which is required to display a high-resolution and low-noise image are set as the application purposes of the reconstructed image.

In addition, the three, (a) a captured image, (b) a past captured image, and (c) a high-speed captured image obtained by reducing the number of projection images are set as input images for the respective application purposes. In this embodiment, with respect to nine combinations obtained by combining the application purposes (i to iii) of the reconstructed image and the input images (a to c), the parameter setting unit 101 sets the parameters (the image input parameter, the pre-process parameter, the reconstruction parameter, and the image output parameter) and the calculation count setting unit 104 determines the calculation count based on the parameters input from the parameter setting unit 101.

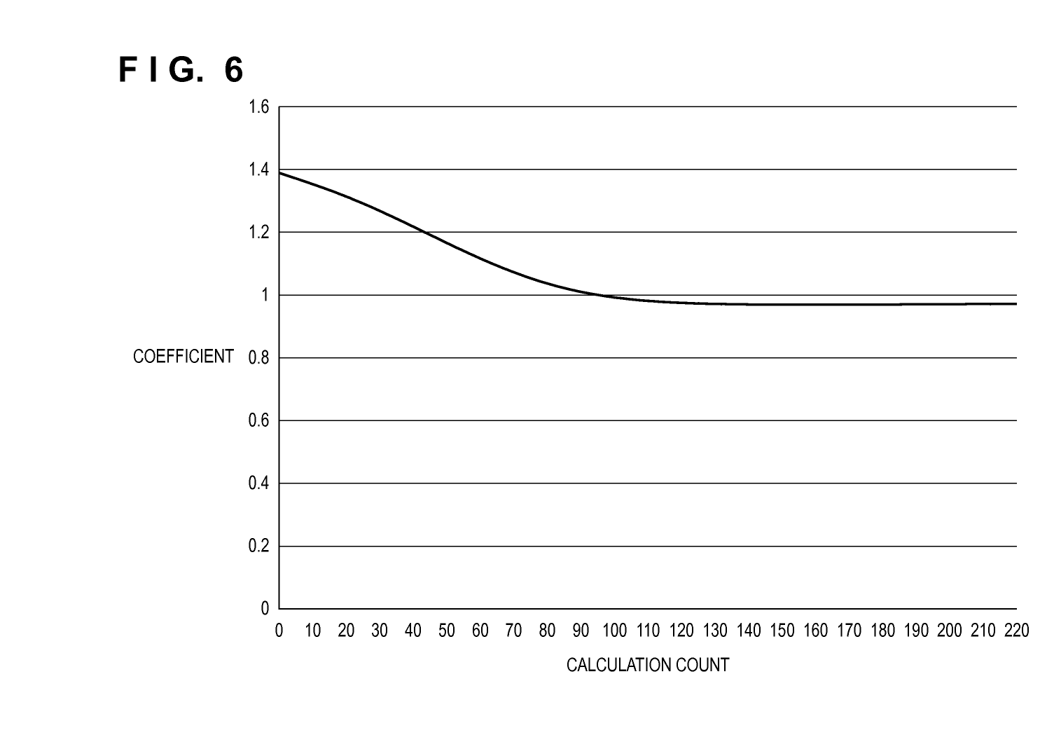

The relationship between the calculation count and a coefficient indicating the degree of an image convergence will now be described. FIG. 6 is a graph exemplifying the relationship between the calculation count and the coefficient obtained by the coefficient calculation unit 303. Assume that the coefficient approaches 1 and the convergence progresses as a change in the coefficient becomes smaller even though the calculation count increases. When the high-quality image is required, calculation needs repetition until the convergence progresses to some extent. Conversely, the convergence has not made much progress as the calculation count is smaller. This makes it difficult to ensure the high-quality image.

In addition, the calculation count directly influences a processing time. The processing time becomes longer as the calculation count is larger and the processing time becomes shorter as the calculation count is smaller. Furthermore, as the number of pixels of the projection images and the number of pixels of the reconstructed image are smaller, a time required for one repetitive calculation operation becomes shorter. Therefore, when compared with the same calculation count, the overall processing time becomes shorter as the respective numbers of pixels are smaller.

On other hand, when performing simple display, an image can be displayed at higher speed than in displaying the high-quality image even at the calculation count (for example, the calculation count of less than 100 in FIG. 6) where the coefficient does not converge as compared with a case in which the high-quality image is obtained.

Taking the captured image for simple display 501 in FIGS. 5A and 5B as the example, the calculation count setting method when setting the parameters the captured image for simple display will now be described with reference to FIGS. 5, 7, and 8. The reconstructed image for simple display purpose with respect to the captured image is required to display an image immediately.

A parameter setting to be described below exemplifies the case of the captured image for simple display 501 in FIGS. 5A and 5B. The parameter setting unit 101 sets, as the image input parameter, the number of images to, for example, 1,024 in order to obtain a high-resolution and low-noise image so that a diagnostic image can be formed after simple display. The parameter setting unit 101 also sets the number of input pixels to, for example, 2,000×3,000 pixels, the pixel pitch to, for example, 150 μm, and the imaging dose to, for example, 6 mGy.

As compared with the setting of the image input parameter, the parameter setting unit 101 reduces the number of pixels to be set to, for example, 1,000×1,500 pixels, increases the pixel pitch to be set to, for example, 300 μm, and reduces the number of images to be set to, for example, 512 in the pre-process parameter. This allows for high-speed display.

The parameter setting unit 101 also sets the reconstruction parameter to a parameter compatible with high-speed display such that the reconstructed image can be displayed at high speed. The parameter setting unit 101 sets the resolution to, for example, 400 μm so as to be compatible with high-speed display. The parameter setting unit 101 also sets the slice interval to, for example, 400 μm and sets the slice thickness to, for example, 50 mm. Further, the parameter setting unit 101 sets the number of pixels of the reconstructed image to the number of pixels which is smaller than the number of pixels in the image input parameter and the number of pixels in the pre-process parameter to, for example, 512×512 pixels in order to obtain the image at high speed.

The parameter setting unit 101 sets, in the image output parameter, the noise reduction process as image output image processing so as to reduce the calculation count and sets a display for the simple display purpose as the image output destination.

(Arrangement of Calculation Count Setting Unit 104)

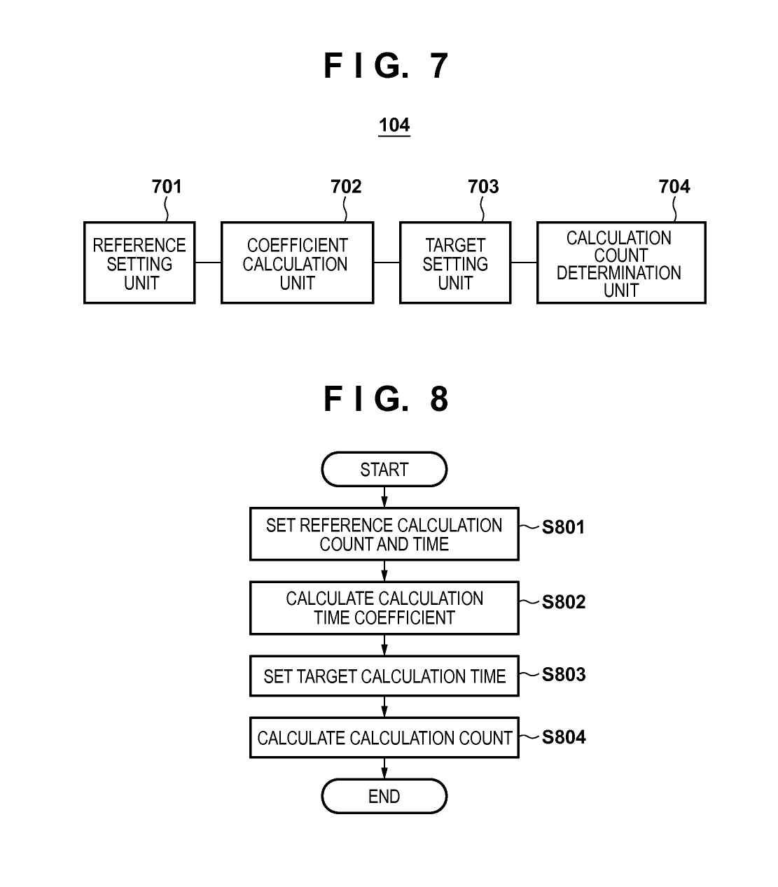

The arrangement of the calculation count setting unit 104 will now be described in detail. The calculation count setting unit can set the calculation count based on the parameter regarding quality of the reconstructed image to be generated and the calculation speed (calculation time) of reconstruction calculation. FIG. 7 is a block diagram showing the functional arrangement of the calculation count setting unit 104. FIG. 8 is a flowchart for explaining the processing sequence of the calculation count setting unit 104. As shown in FIG. 7, the calculation count setting unit 104 includes a reference setting unit 701, a coefficient calculation unit 702, a target setting unit 703, and a calculation count determination unit 704.

The operation of each unit of the calculation count setting unit 104 will now be described with reference to the processing sequence in FIG. 8. First, in step S801, the reference setting unit 701 sets a reference calculation count and a reference calculation time. At this time, the calculation count serving as the reference is obtained by an experiment or the like and is a count (reference convergence count) at which the coefficient converges sufficiently. As the calculation time serving as the reference, a calculation time corresponding to that calculation count can be set. In this embodiment, assume that the reference calculation count is 200 and the calculation time at that time is 200 min, for example.

Next, in step S802, the coefficient calculation unit 702 calculates a calculation time coefficient. At this time, a calculation time coefficient (α) is calculated by:

α=(P×J×R×D×S_{b})/(P_{b}×J_{b}×R_{b}×S×D_{b}) (1)

where α represents the calculation time coefficient, P is the number of pixels of the projection images set by the pre-process parameter (the number of pixels of images to be input when the pre-process is not performed), J is the number of projection images set by the pre-process parameter (the number of images to be input when the pre-process is not performed), R is the number of pixels of the reconstructed image set by the reconstruction parameter, S is a slice interval, and D is a slice thickness.

P_{b}, J_{b}, R_{b}, S_{b}, and D_{b}, respectively, are the number of pixels of the projection images, the number of projection images, the number of pixels of the reconstructed image, the slice interval, and the slice thickness when determining the reference convergence count.

In this embodiment, taking the setting of the captured image for simple display in FIGS. 5A and 5B as the example, the number P of pixels of the projection images is 1,000×1,500 pixels, the number J of projection images is 512, the number R of pixels of the reconstructed image is 512 pixels×512 pixels, the slice interval S is 400 μm, and the slice thickness D is 50 mm.

If the reference convergence count is calculated in the highest-resolution image (the reconstructed image for a calcification-diagnostic purpose in FIGS. 5A and 5B), the number P_{b} of pixels of the projection images is 2,000×3,000 pixels, the number J_{b} of projection images is 1,024, the number R_{b} of pixels of the reconstructed image is 1,024×1,024 pixels, the slice interval S_{b} is 200 μm, and the slice thickness D_{b} is 200 mm. If the coefficient calculation unit 702 calculates the calculation time coefficient α by applying the values of the respective parameters to equation (1), the calculation time coefficient α of 0.00390625 is obtained.

In this embodiment, the calculation time coefficient is calculated by using the above-described parameters. However, the present invention is not limited to this. The parameter regarding quality of the reconstructed image to be generated and the calculation speed (calculation time) of reconstruction calculation can be used. For example, the present invention comprises an analysis unit which analyzes object information based on an image to be input. The analysis unit analyzes object information (for example, information indicating the size of the object, the shape of the object, the symmetry of the shape of the object, the body part to be imaged of the object, and the homogeneity of the body part to be imaged of the object). The parameter set by the parameter setting unit 101 contains information on the analyzed object. Object information contained in the parameter includes at least one piece of information out of information indicating the size of the object, information indicating the shape of the object, information indicating the symmetry of the shape of the object, information indicating the body part to be imaged of the object, and information indicating the homogeneity of the body part to be imaged of the object.

The coefficient calculation unit 702 of the calculation count setting unit 104 can calculate and change the calculation time coefficient (α) based on object information analyzed by the analysis unit. This is because the relationship between convergence and the calculation count also changes depending on what kind of image is targeted for reconstruction. For example, the calculation count needs to be increased for a part such as a breast high in symmetry and homogeneity as compared with a part such as a chest low in symmetry and homogeneity.

Next, in step S803, the target setting unit 703 sets a target calculation time. The target calculation time is changed depending on the output destination of the image output parameter. In this embodiment, the display for the simple display purpose is used, and thus the target calculation time is set to 10 sec. In this embodiment, the target calculation time is determined depending on the output destination. However, the target calculation time may be determined in accordance with the application purpose or a method of inputting a target time setting directly may be used.

Next, in step S804, the calculation count determination unit 704 determines a calculation count by:

Nₜ=(Tₜ×N_{b})/(T_{b}×α) (2)

where Nₜ is a calculation count, Tₜ is a target calculation time, N_{b} is a reference calculation count, T_{b} is a reference calculation time, and α is the calculation time coefficient. The target calculation time Tₜ is 10 sec, the reference calculation count N_{b} is 200, the reference calculation time T_{b} is 200 min, and the calculation time coefficient α is 0.00390625 which is a value calculated by the coefficient calculation unit 702 by using equation (1) described above.

If the calculation count determination unit 704 calculates the calculation count Nₜ by applying the values of the respective parameters to equation (2), the calculation count Nₜ of 25.6 is obtained. In order to obtain the calculation count as an integer, the calculation count determination unit 704 obtains, as the calculation count, 25 which is obtained by truncating after the decimal point.

25 calculation operations are not enough to complete convergence and desired image quality may not be ensured. Even in this case, it is possible, in this embodiment, to ensure sufficient image quality for simple display by performing the noise reduction process based on the setting of the image output parameter.

As described above, the setting of the calculation count by the calculation count setting unit 104 is completed by performing the process in steps S801 to S804. In this embodiment, the calculation count is 25 which is one-eighth of the reference calculation count of 200. However, the calculation count may be set by setting the lowest calculation count (lower limit calculation count) in order to obtain a reconstructed image of predetermined quality. It becomes possible to obtain an image of target quality within a limited processing time not only by determining the calculation count in accordance with the parameter as described above but also by changing a parameter which processes an output image in accordance with the calculation count on a certain condition.

In this embodiment, the reference calculation count is 200. However, this can also be determined in accordance with the application purpose, the output destination, or the like. For example, the reference calculation count may be 100 for the tumor-diagnostic purpose and 200 for a calcification detection purpose. Image quality and the calculation time can be adjusted easily by setting the reference calculation count in accordance with the application purpose as described above.

The degree of the noise reduction process and whether to perform the process itself may be changed in accordance with the ratio of the calculation count to the reference calculation count. As described above, it becomes possible to generate a reconstructed image with a desired calculation time and quality by setting the calculation count in accordance with the image input parameter, the pre-process parameter, the reconstruction parameter, and the like.

In this embodiment, the setting of the calculation count has been described by taking the case of the captured image for simple display as the example. However, the arrangement of this embodiment can equally be applied, based on the set parameters, to the combination of another input image and the application purposes shown in FIGS. 5A and 5B. For example, in a captured image for the tumor-diagnostic purpose 502 in FIGS. 5A and 5B, the calculation count increases to 100 as compared with the calculation count of 25 in the captured image for simple display 501 and it becomes possible to provide a reconstructed image in a state in which a reconstruction calculation result converges more than in the captured image for simple display. Furthermore, in a high-speed captured image for the calcification-diagnostic purpose 503, the calculation count further increases to 200 as compared with the calculation count of 100 in the captured image for the tumor-diagnostic purpose 502 and it becomes possible to provide a reconstructed image in a state in which the reconstruction calculation result converges much more than in the captured image for the tumor-diagnostic purpose 502. For example, an increase in the calculation count makes the calculation time longer but brings about the state in which the reconstruction calculation result converges, thus making it possible to generate the high-quality reconstructed image.

According to this embodiment, it becomes possible to generate the reconstructed image in accordance with the application purpose. It becomes possible to generate a reconstructed image of quality needed in accordance with the application purpose in the calculation time (at the calculation speed) in accordance with the application purpose.

(Modification 1)

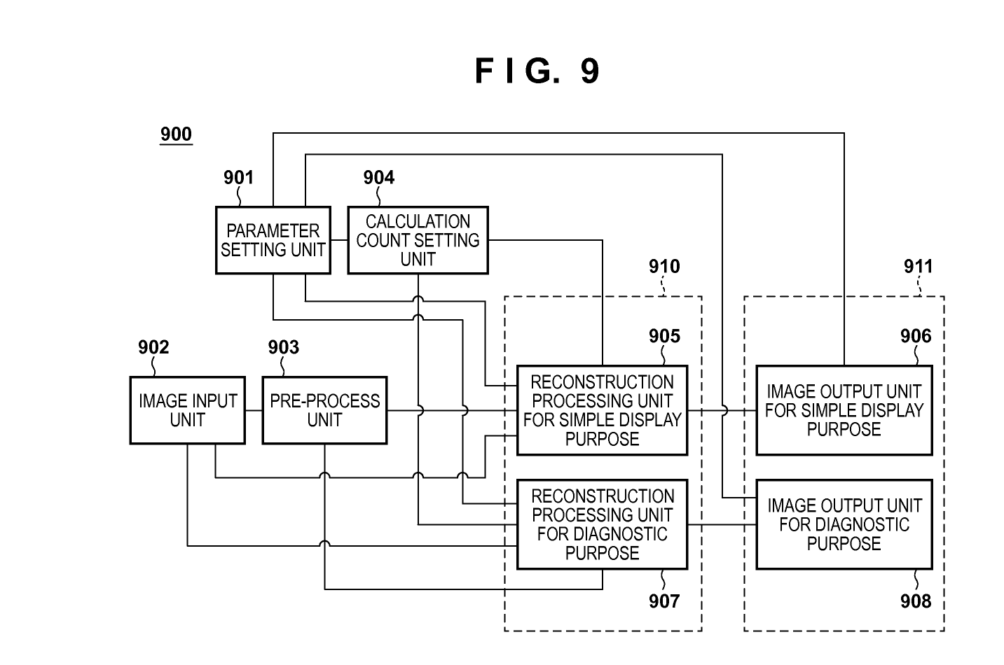

In the above-described embodiment, the functional arrangement in which the image processing apparatus 100 includes the parameter setting unit 101, the image input unit 102, the pre-process unit 103, the calculation count setting unit 104, the reconstruction processing unit 105, and the image output unit 106 has been described. Under this functional arrangement, the example of obtaining the calculation count when performing simple display on the captured image has been described. However, the arrangement in FIG. 1 can also be modified as shown in FIG. 9.

FIG. 9 is a block diagram showing the functional arrangement of an image processing apparatus 900 according to a modification. In the functional arrangement of the image processing apparatus 900 shown in FIG. 9, a parameter setting unit 901, an image input unit 902, a pre-process unit 903, and a calculation count setting unit 904 are the same as the parameter setting unit 101, the image input unit 102, the pre-process unit 103, and the calculation count setting unit 104 of the image processing apparatus 100 described in FIG. 1.

A reconstruction processing unit 910 includes a reconstruction processing unit 905 for a simple display purpose (first reconstruction processing unit) which generates a reconstructed image of the first resolution and a reconstruction processing unit 907 for a diagnostic purpose (second reconstruction processing unit) which generates a reconstructed image of the second resolution higher than the first resolution. The reconstruction processing unit 905 for the simple display purpose (first reconstruction processing unit) and the reconstruction processing unit 907 for the diagnostic purpose (second reconstruction processing unit) are configured such that they can perform processing in parallel.

An image output unit 911 includes an image output unit 906 for the simple display purpose (first image output unit) which displays the reconstructed image output from the reconstruction processing unit 905 for the simple display purpose (first reconstruction processing unit) and an image output unit 908 for the diagnostic purpose (second image output unit) which displays the reconstructed image output from the reconstruction processing unit 907 for the diagnostic purpose (second reconstruction processing unit).

The parameter setting unit 901 sets respective parameters for the image input unit 902, the pre-process unit 903, the reconstruction processing unit 905 for the simple display purpose and the image output unit 906, and the reconstruction processing unit 907 for the diagnostic purpose and the image output unit 908.

The calculation count setting unit 904 sets, based on an image input parameter, a pre-process parameter, a reconstruction parameter, and an image output parameter input from the parameter setting unit 901, calculation counts output to the reconstruction processing unit 905 for the simple display purpose and the reconstruction processing unit 907 for the diagnostic purpose. The calculation count setting unit 904 sets the calculation count of the reconstruction processing unit 905 for the simple display purpose (first reconstruction processing unit) to be smaller than that of the reconstruction processing unit 907 for the diagnostic purpose (second reconstruction processing unit).

The reconstruction processing unit 905 for the simple display purpose generates a reconstructed image based on the calculation count set for the simple display purpose. The image output unit 906 for the simple display purpose outputs, based the image output parameter input from the parameter setting unit 901, the reconstructed image obtained from the reconstruction processing unit 905 for the simple display purpose.

In parallel with this processing, the reconstruction processing unit 907 for the diagnostic purpose generates the reconstructed image based on the calculation count set for the diagnostic purpose and the image output unit 908 for the diagnostic purpose outputs, based on the image output parameter input from the parameter setting unit 901, the reconstructed image obtained from the reconstruction processing unit 907 for the diagnostic purpose. It becomes possible to attempt an improvement in workflow efficiency by performing simple display on a captured image and forming, in parallel with that, a diagnostic image by another processing unit.

(Modification 2)

In the above-described embodiment, the configuration example in which the calculation count setting unit 104 sets the calculation count based on the parameter regarding quality of the reconstructed image to be generated and the calculation speed (calculation time) required for reconstruction calculation has been described. However, the gist of the present invention is not limited to this example. For example, the calculation count setting unit 104 can set the calculation count based on a parameter including the characteristics of a plurality of input images and the characteristics of the reconstructed image to be generated. The calculation count setting unit 104 sets the calculation count based on, for example, a parameter including qualities of the plurality of input images and quality of the reconstructed image to be generated. The calculation count setting unit 104 can set the calculation count based on, for example, a parameter regarding quality of the reconstructed image to be generated in accordance with an application purpose and a calculation speed of reconstruction calculation. Alternatively, the calculation count setting unit 104 can set the calculation count based on a parameter regarding quality of the reconstructed image to be generated in accordance with the application purpose and the calculation time of reconstruction calculation. Then, a reconstruction processing unit 105 generates a reconstructed image by performing, based on the set calculation count, reconstruction calculation on the plurality of images repeatedly. According to modification 2, it becomes possible to generate the reconstructed image having characteristics needed in accordance with the application purpose.

According to the embodiment and the respective modifications described above, it becomes possible to generate the reconstructed image in accordance with the application purpose.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2014-261245, filed Dec. 24, 2014, which is hereby incorporated by reference herein in its entirety.

What is claimed is:

1. An image processing apparatus which generates a reconstructed image based on a plurality of images, the apparatus comprising:
an image input unit configured to input the plurality of images;
a calculation count setting unit configured to set a calculation count in accordance with an application purpose of the reconstructed image; and
a reconstruction processing unit configured to generate the reconstructed image by performing reconstruction calculation on the plurality of images repeatedly based on the calculation count.

2. An image processing apparatus which generates a reconstructed image based on a plurality of images, the apparatus comprising:
an image input unit configured to input the plurality of images;
a calculation count setting unit configured to set a calculation count based on a parameter including characteristics of the plurality of input images and a characteristic of the reconstructed image to be generated; and
a reconstruction processing unit configured to generate the reconstructed image by performing reconstruction calculation on the plurality of images repeatedly based on the calculation count.

3. The apparatus according to claim 1, wherein the application purpose of the reconstructed image is one of a simple display purpose and a diagnostic purpose.

4. The apparatus according to claim 1, wherein the calculation count setting unit sets, to be distinguished from each other, a calculation count for a simple display purpose which is required to display a low-quality reconstructed image at high speed and a calculation count for a diagnostic display purpose which is required to display a high-quality reconstructed image.

5. The apparatus according to claim 1, wherein the calculation count setting unit sets, to be distinguished from each other, a calculation count for a simple display purpose which is required to display a low-quality reconstructed image at high speed, a calculation count for a first diagnostic display purpose which is required to display a noise-reduced reconstructed image, and a calculation count for a second diagnostic display purpose which is required to display a high-quality and noise-reduced reconstructed image.

6. The apparatus according to claim 1, wherein the calculation count setting unit sets the calculation count based on a parameter regarding quality of the reconstructed image to be generated in accordance with the application purpose and a calculation speed of reconstruction calculation.

7. The apparatus according to claim 1, wherein the calculation count setting unit sets the calculation count based on a parameter regarding quality of the reconstructed image to be generated in accordance with the application purpose and a calculation time of reconstruction calculation.

8. The apparatus according to claim 2, further comprising a parameter setting unit configured to set the parameter based on an application purpose of the reconstructed image specified via an operation unit,
wherein the parameter includes
an image input parameter to perform input processing on the plurality of images, and
a reconstruction parameter to generate the reconstructed image.

9. The apparatus according to claim 8, wherein the image input parameter contains information indicating the number of pixels of the images to be input and the number of the images, and
the reconstruction parameter contains information indicating the number of pixels of the reconstructed image, a slice interval, and a slice thickness.

10. The apparatus according to claim 8, wherein the image input unit inputs, based on the image input parameter, a plurality of images captured from different angles.

11. The apparatus according to claim 8, wherein the reconstruction processing unit includes a calculation count determination unit configured to determine whether calculation by a set calculation count is completed,
if calculation by the calculation count is not completed, the reconstruction processing unit performs the reconstruction calculation based on the reconstruction parameter, and
if calculation by the calculation count is completed, the reconstruction processing unit outputs the reconstructed image generated by the reconstruction calculation.

12. The apparatus according to claim 8, wherein the reconstruction processing unit includes
a first reconstruction processing unit configured to generate a reconstructed image of a first resolution, and
a second reconstruction processing unit configured to generate a reconstructed image of a second resolution higher than the first resolution, and
the first reconstruction processing unit and the second reconstruction processing unit perform processing in parallel.

13. The apparatus according to claim 12, wherein the calculation count setting unit sets a calculation count of the first reconstruction processing unit to be smaller than that of the second reconstruction processing unit.

14. The apparatus according to claim 12, further comprising an image output unit configured to output the generated reconstructed image,
wherein the image output unit includes
a first image output unit configured to display the reconstructed image output from the first reconstruction processing unit, and
a second image output unit configured to display the reconstructed image output from the second reconstruction processing unit.

15. The apparatus according to claim 14, wherein the parameter setting unit sets an image output parameter to perform output processing on the reconstructed image, and
the image output unit performs output processing set by the image output parameter on the reconstructed image.

16. The apparatus according to claim 15, wherein output processing set by the image output parameter includes a noise reduction process.

17. The apparatus according to claim 6, further comprising an analysis unit configured to analyze object information based on the images to be input,
wherein the parameter contains the analyzed object information.

18. The apparatus according to claim 17, wherein the object information contained in the parameter includes at least one piece of information out of information indicating a size of the object, information indicating a shape of the object, information indicating a symmetry of the shape of the object, information indicating a body part to be imaged of the object, and information indicating homogeneity of the body part to be imaged of the object.

19. An image processing method of generating a reconstructed image based on a plurality of images, the method comprising:
inputting the plurality of images;
setting a calculation count in accordance with an application purpose of the reconstructed image; and
generating the reconstructed image by performing reconstruction calculation on the plurality of images repeatedly based on the calculation count.

20. An image processing method of generating a reconstructed image based on a plurality of images, the method comprising:
inputting the plurality of images;
setting a calculation count based on a parameter including characteristics of the plurality of input images and a characteristic of the reconstructed image to be generated; and
generating the reconstructed image by performing reconstruction calculation on the plurality of images repeatedly based on the calculation count.

21. A computer-readable storage medium storing a program for causing a computer to function as each unit of an image processing apparatus which generates a reconstructed image based on a plurality of images, the image processing apparatus comprising:
an image input unit configured to input the plurality of images;
a calculation count setting unit configured to set a calculation count in accordance with an application purpose of the reconstructed image; and
a reconstruction processing unit configured to generate the reconstructed image by performing reconstruction calculation on the plurality of images repeatedly based on the calculation count.
